(19) United States
(12) Patent Application Publication
(10) Pub. No.: US 2003/0061142 A1
(43) Pub. Date: Mar. 27, 2003

(54) Apparatus and Method of trading right to use electric communications equipment and apparatus and method of assigning capacity of electric communications equipment

(76) Inventors: Shigeru Ikeda, Tokyo (JP); Atsushi Yano, Tokyo (JP); Shigetsune Yamoto, Tokyo (JP); Kiyoto Fukamatsu, Tokyo (JP)

Correspondence Address: Darby & Darby, 805 Third Avenue, New York, NY, 10022, US

(21) Appl. No.: 09/936,081

(22) PCT Filed: Jan. 12, 2001
(86) PCT No.: PCT/JP01/00155

(30) Foreign Application Priority Data
Jan. 12, 2000 (JP) P2000-004071
Jan. 10, 2001 (JP) P2001-002613

(51) Int. Cl. G06F 17/60

(52) U.S. Cl. 705/37

(57) ABSTRACT

To provide an apparatus for trading a right to use electric communications equipment, which can permit an electric communications equipment user, who is renting electric communications equipment from a communication company, to share electric communications equipment capacity with other electric communications equipment users and the communication company when there is a temporary excess or a deficiency of electric communications equipment capacity. The apparatus comprises a seller terminal (300) for accepting a consignment to sell a right to use electric communications equipment corresponding to a surplus electric communications equipment capacity a first registered user has contracted with a communication company, a buyer terminal (400) for accepting a consignment to buy a right to use electric communications equipment corresponding to a shortage of electric communications equipment capacity a second registered user has contracted with a communication company, and an electric-communications-equipment use-right brokerage unit (900) for intermediating between the consignment to sell the right to use electric communications equipment of the first registered user and the consignment to buy the right to use electric communications equipment of the second registered user to conclude transfer of the right to use electric communications equipment.

### TECHNICAL FIELD

The present invention relates to an apparatus and method of trading a right to use electric communications equipment, which can permit a user of electric communications equipment, such as a network link, to share the electric communications equipment capacity with other electric communications equipment users and a communication company. The invention also relates to an apparatus and method of assigning the capacity of electric communications equipment, which provides electric communications equipment on another path that handles excess demand or flexibly changes the assignment of electric communications equipment capacity among electric communications equipment users, when the use by an electric communications equipment user temporarily exceeds the electric communications equipment capacity.

### BACKGROUND ART

At present, fast data communications networks operating at about 100 Mbps using optical fibers have been built in Japan, Europe, the U.S., and the ASEAN countries. With such optical-fiber based fast data communications networks, large enterprises that have multiple nodes in Japan are able to secure the smooth exchange of business information over various locations over intra-office LAN's or intranets. Medium and small-sized enterprises and large enterprises can effectively use the Internet or value-added networks (VAN) to do business with other companies.

FIG. 16 is a structural diagram of an optical fiber fast data communications network in Japan, constructed by a communications company. There is a trunk data communications network which has main nodes in Tokyo, Osaka, Fukuoka and Sapporo. Between Tokyo and Sapporo, there is a direct line, and a via-Sendai line which goes from Tokyo to Sendai and from Sendai to Sapporo as the main paths. Between Tokyo and Osaka, likewise, there is a direct line, and a via-Nagoya line which goes from Tokyo to Nagoya and from Nagoya to Osaka, as the main paths. Between Osaka and Fukuoka, there is a direct line and a via-Hiroshima line, from Osaka to Hiroshima and from Hiroshima to Fukuoka, as the main paths. Between Sapporo and Fukuoka, there is a direct line of small line capacity and a trunk line of large capacity which runs through Sapporo-Tokyo-Osaka-Fukuoka. In this way, domestic foothold cities are connected by an optical fiber fast data communications network.

FIG. 17 is an explanatory diagram of an inter-business information communication system using a fast data communications network. The fast data communications network has an access point AP provided for each of the head office of a company A, a factory of the company A, a branch office of the company A, the head office of a company B, a sales office of a company C, and the head office of a company D. As the fast data communications network IP is connected to a web site on the Internet via a fast and large-capacity cache server, it is not affected by heavy use of the Internet or the server and can ensure fast web access. Each access point AP is connected to the server of each company by an optical fiber, a copper cable, a communication device using a lamp wire, mobile communication radio, Bluetooth, PHS (Personal Handy Phone System) or the like. A CUG (Closed User Group) forms a closed network which does not permit connection by parties other than registered service users and can provide high security.

FIG. 18 is an explanatory diagram of a service structure using a public fast data communications network. A fast data communications network 10 is provided with a fast bearer (exclusive line) service 12, a fast IP (Internet Protocol) extra network service 14 and a fast Internet connection service 16. Each enterprise constructs its own information system, as an IP multimedia application 30, on a platform 20 using the fast data communications network 10. The IP multimedia application 30 includes a video application 32, a speech application 34, a data application 36 and so forth. An information communication system builder provides problem solving means 40 for enterprises which are their customers, such as an intranet 42 which permits intra-office sharing of order and shipment information among sales offices or factories, an extranet 44 which permits sharing of intra-office information with associated extra-office dealers, such as agents, physical distributors and parts suppliers, and a digital business 46 such as an electronic commerce business.

FIG. 19 is a diagram showing an example of data traffic over a LAN. As a LAN (Local Area Network), which constitutes a part of the fast data communications network 10, carries out burst data communication such as the communication among IP routers, the over-LAN communication traffic has the property that it drops to a significantly low level at times other than the peak times. With a maximum band of 0.8 Mbps, for example, the average traffic is merely 0.2 Mbps. In a band guarantee type service which is suitable for host system communications in which short delays and a fixed band are necessary, and for speech/video communications, the communication cost becomes higher for users while, from the viewpoint of communications equipment managers, the large-capacity communication line is fully used for only a limited time.

FIG. 20 is an explanatory diagram of an effective band use type service. In the effective band use type service, communication lines having a maximum communication band of 1 Mbps are jointly used by three companies A, B and C. Each company secures, for example, 0.2 Mbps as the minimum guaranteed band and secures the remainder of the 1 Mbps depending on the state of use by the other companies participating in the joint usage. Such an assignment of the band usage among co-users is accomplished by the buffer function of the ATM (Asynchronous Transfer Mode) switch. The effective band use type service has the advantages that the communication cost is low for users and the line use efficiency is improved for communications equipment managers, thus requiring a lower investment for the equipment.

To carry out a policy for international telephony and telegraphy commerce of securing reliable communications, conventionally, communications equipment managers could build large-capacity fast data communications networks that commensurate with demands and charge users with communication rates commensurate with the capital investment. However, it is necessary to construct a communications network which ensures a low communication cost for users and improves the line use efficiency for communications equipment managers, thus requiring less investment in equipment, not only for relatively small-scale communications networks such as LAN's but also for optical fiber fast data communications networks which cover domestic communication networks in Japan, and submarine optical fiber fast data communications networks which cover Asia, the U.S. and Europe. The use of the scheme of executing assignments of communication resources by reservation based on estimates (see Published Japanese Translation No. Hei 6-507289 of PCT International Publication) in such a usage does not guarantee the optimal line use efficiency for the various demands of customers.

### DISCLOSURE OF THE INVENTION

The present invention overcomes the above-described problems and its first object is to provide an apparatus for trading a right to use electric communications equipment, which can permit an electric communications equipment user, who is renting electric communications equipment, such as a network line, from a communication company, to share electric communications equipment capacity with other electric communications equipment users and the communication company when there is a temporary excess or a deficiency of electric communications equipment capacity. Its second object is to provide an apparatus for assigning the capacity of electric communications equipment, which provides electric communications equipment on another path which handles excess demand or flexibly changes the assignment of the electric communications equipment capacity among electric communications equipment users in consideration of the communication service quality for an electric communications equipment user, when the use by the electric communications equipment user, who is renting electric communications equipment, such as a network line, from a communication company, temporarily exceeds the electric communications equipment capacity.

An apparatus for trading a right to use electric communications equipment, which achieves the first object, is an electric-communications-equipment-use-right trading apparatus shown in, for example, FIG. 14, and has a structure that comprises a means (seller terminal 300) which accepts a consignment to sell a right to use electric communications equipment corresponding to a surplus electric communications equipment capacity a first registered user has contracted with a communication company; a means (buyer terminal 400) which accepts a consignment to buy a right to use electric communications equipment corresponding to a shortage of electric communications equipment capacity a second registered user has contracted with a communication company; and market brokerage means (electric communications-equipment-use-right market brokerage unit 900) which mediates between the consignment to sell the right to use electric communications equipment of the first registered user and the consignment to buy the right to use electric communications equipment of the second registered user to conclude the transfer of the right to use electric communications equipment. This can permit an electric communications equipment user, who is renting electric communications equipment from a communication company, to share electric communications equipment capacity with other electric communications equipment users and the communication company when there is a temporary excess or a deficiency of electric communications equipment capacity.

The apparatus for trading a right to use electric communications equipment is preferably constructed to comprise electric-communications-equipment-use-right price index means (electric-communications-equipment-use-right price index unit 1000) which collects the price of the consignments to sell and the price of the consignments to buy the right to use electric communications equipment from the registered users, and which sets a lower unit price for the right to use electric communications equipment in a period in which the price of the consignments to sell the right to use electric communications equipment exceed the price of the consignments to buy, and which sets a higher unit price for the right to use electric communications equipment in a period in which the price of the consignments to sell the right to use electric communications equipment is below the price of the consignments to buy. This increases the probability of making a transfer contract via the market brokerage unit. The right to use electric communications equipment should include at least one of a line use right, a right to use application equipment and a right to use an ASP server, and the electric communications equipment capacity includes at least one of a line capacity, an application equipment processing capacity and an ASP server processing capacity.

An apparatus for assigning a capacity of electric communications equipment, which achieves the second object, comprises a means (corresponding to, for example, line use capacity computing means 650 in FIG. 8) which collects and analyzes traffic data of registered users and computes the usage rate of an electric-communications-equipment over a period equivalent to a time unit for transactions of the right to use the electric communications equipment; monitoring means (corresponding to, for example, line-use-right trade market monitoring means 660 in FIG. 8) which monitors the trading of the right to use electric communications equipment to be traded in a market for trading the right to use electric communications equipment; and a means (corresponding to, for example, a bypass-line providing unit 700 in FIG. 8) which provides other electric communications equipment having a surplus capacity as bypass electric communications equipment (corresponding to, for example, a bypass line 605 in FIG. 8) to bypass electric communications equipment having insufficient capacity, for electric communications equipment (corresponding to, for example, a fast data communications network 600 in FIG. 8) for which the monitoring means determines that the transaction price for the right to use electric communications equipment becomes high due to a shortage in electric communications equipment capacity provided by a communication company. This can provide electric communications equipment on another path that handles excess demands when the use of by an electric communications equipment user, who is renting electric communications equipment, such as a network line, from a communication company, temporarily exceeds the electric communications equipment capacity.

An apparatus for assigning a capacity of electric communications equipment according to another aspect to achieve the second object, is designed to comprise a means (corresponding to, for example, line use capacity computing means 650 in FIG. 11) which collects and analyzes traffic data of registered users and computes the usage rate of an electric-communications-equipment over a period equivalent to a time unit for transactions of the right to use the electric communications equipment; monitoring means (corresponding to, for example, line-use-right trade market monitoring means 660 in FIG. 11) which monitors the trading of the right to use electric communications equipment to be traded in a market for trading the right to use electric communications equipment; and a unit (corresponding to, for example, a unit for providing a line for each contractor 800 in FIG. 11) for providing electric communications equipment for each contractor which, for electric communications equipment for which the monitoring means determines that a transaction price for the right to use electric communications equipment becomes high due to a shortage in electric communications equipment capacity provided by a communication company, preferentially provides a customer having a contract for high communication quality use of electric communications equipment with electric communications equipment capacity, and subsequently provides a customer having a contract for low communication quality use of electric communications equipment with the electric communications equipment capacity. This makes it possible to flexibly change the assignment of the electric communications equipment capacity among electric communications equipment users in conformity with the communication service quality for an electric communications equipment user, when the use by the electric communications equipment user, who is renting electric communications equipment, such as a network line, from a communication company, temporarily exceeds the electric communications equipment capacity.

The electric-communications-equipment capacity assigning apparatus according to the above-described aspect is preferably constructed to comprise a means which makes a decision in such a way that a ratio of (a) an electric communications equipment capacity secured by the unit for providing electric communications equipment for each contractor, for a customer having a contract for high communication quality use of the electric communications equipment to (b) an electric communications equipment capacity secured by the unit for providing electric communications equipment for each contractor, for a customer having a contract for low communication quality use of the electric communications equipment does not excessively deviate from the difference in contracted unit price between the high communication quality use and the low communication quality use. It is possible to prevent assigning limited electric communications equipment capacity to an electric-communications-equipment use contractor, in such a way that excessively high communication service quality is provided in view of the price paid by the customer.

A method of trading a right to use electric communications equipment which achieves the first object is the method to trade a right to use electric communications equipment shown in, for example, FIG. 10, and comprises a step (S100) of accepting a consignment to sell a right to use electric communications equipment corresponding to a surplus electric communications equipment capacity a first registered user has contracted with a communication company; a step (S102) of accepting a consignment to buy a right to use electric communications equipment corresponding to a shortage of electric communications equipment capacity a second registered user has contracted with a communication company; and a market brokerage step (S104) of intermediating between the consignment to sell the right to use electric communications equipment of the first registered user and the consignment to buy the right to use electric communications equipment of the second registered user to conclude the transfer of the right to use electric communications equipment.

A method of assigning a capacity of electric communications equipment which achieves the second object is the electric-communications-equipment capacity assigning method shown in, for example, FIG. 10, and comprises a step (S200) of collecting and analyzing traffic data of registered users and computing the usage rate of an electric-communications-equipment over a period equivalent to a time unit for transactions of the right to use the electric communications equipment; a monitoring step (S202) of monitoring the trading of the right to use the electric communications equipment in a market for trading the right to use electric communications equipment; and a step (S206) of providing other electric communications equipment having a surplus capacity as bypass electric communications equipment to bypass electric communications equipment having insufficient capacity (S204), for which the monitoring step determines that the transaction price for the right to use electric communications equipment becomes high due to a shortage of electric communications equipment capacity provided by a communication company.

A method of assigning a capacity of electric communications equipment according to another aspect to achieve the second object is the method for assigning an electric-communications-equipment capacity shown in, for example, FIG. 13 and comprises a step (S300) of collecting and analyzing traffic data of registered users and computing the usage rate of an electric-communications-equipment over a period equivalent to a time unit for transactions of the right to use the electric communications equipment; a monitoring step (S302) of monitoring the trading of the right to use electric communications equipment to be traded in a market for trading the right to use electric communications equipment; and a step (S304) of providing electric communications equipment for each contractor which, for electric communications equipment for which the monitoring step detects that a transaction price for the right to use electric communications equipment becomes high due to a shortage of electric communications equipment capacity provided by a communication company, a customer having a contract for high communication quality use of electric communications equipment is preferentially provided with electric communications equipment capacity (S306, S308), and subsequently a customer having a contract for low communication quality use of electric communications equipment is provided with the electric communications equipment capacity (S3 10).

### BRIEF DESCRIPTION OF DRAWINGS

FIG. 1 is a structural block diagram for explaining one embodiment of the present invention.

FIG. 2 is a structural block diagram of a line-use-right market brokerage unit.

FIG. 3 is a structural block diagram of a seller terminal.

FIG. 4 is a structural block diagram of a buyer terminal.

FIG. 5 is an explanatory diagram of a line-use-right price index.

FIG. 6 is an explanatory diagram for buying and selling offers for a line use right.

FIG. 7 is a flowchart for explaining a method of trading a right to use electric communications equipment.

FIG. 8 is a structural block diagram for explaining a first embodiment of an apparatus for assigning the capacity of a communication line.

FIG. 9 is a structural block diagram of a bypass-line providing unit.

FIG. 10 is a flowchart for explaining a method of assigning the capacity of electric communications equipment such as a bypass line.

FIG. 11 is a structural block diagram for explaining a second embodiment of an apparatus for assigning the capacity of a communication line.

FIG. 12 is a structural block diagram of a line-for-each-contractor providing unit.

FIG. 13 is a flowchart for explaining a method of assigning the capacity of electric communications equipment such as a communication capacity.

FIG. 14 is a structural block diagram of an apparatus for trading a right to use electric communications equipment.

FIG. 15 is a structural block diagram for explaining an apparatus for assigning the capacity of electric communications equipment.

FIG. 16 is a structural diagram of an optical fiber fast data communications network in Japan, which is constructed by a communication company.

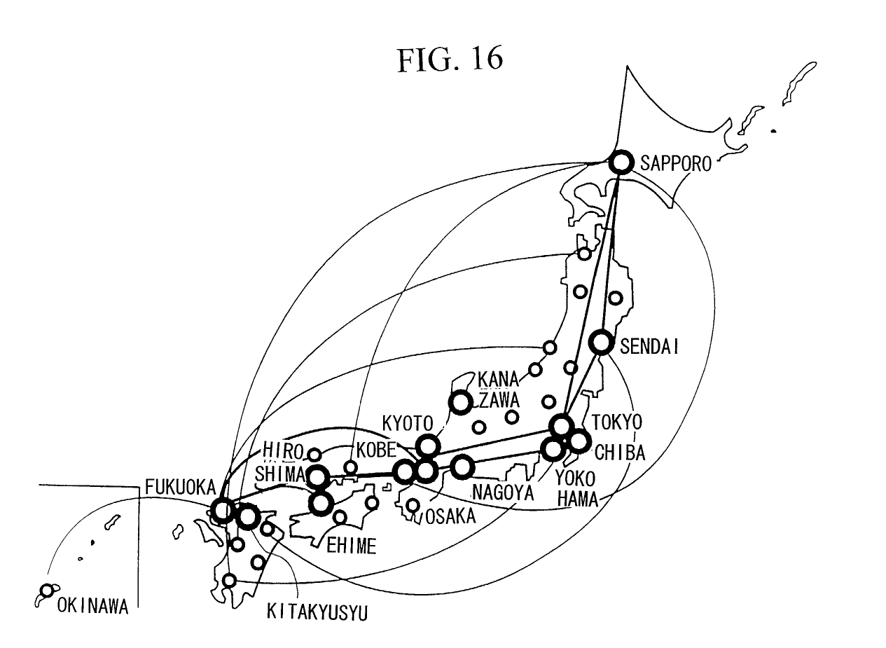

FIG. 17 is an explanatory diagram of an intra-business information communication system using a fast data communications network.

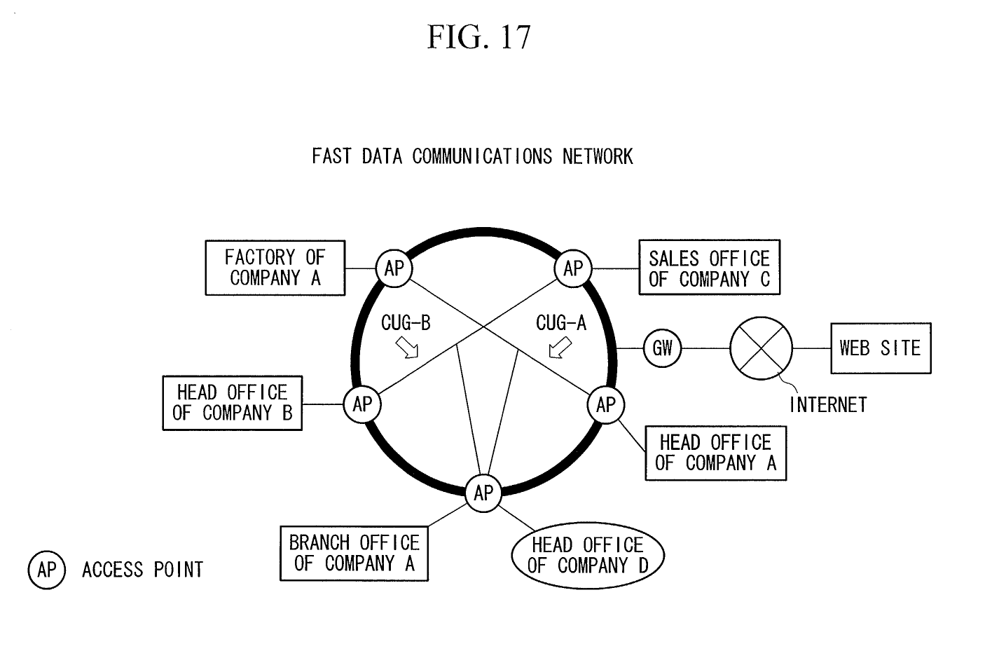

FIG. 18 is an explanatory diagram of a service structure using a public fast data communications network.

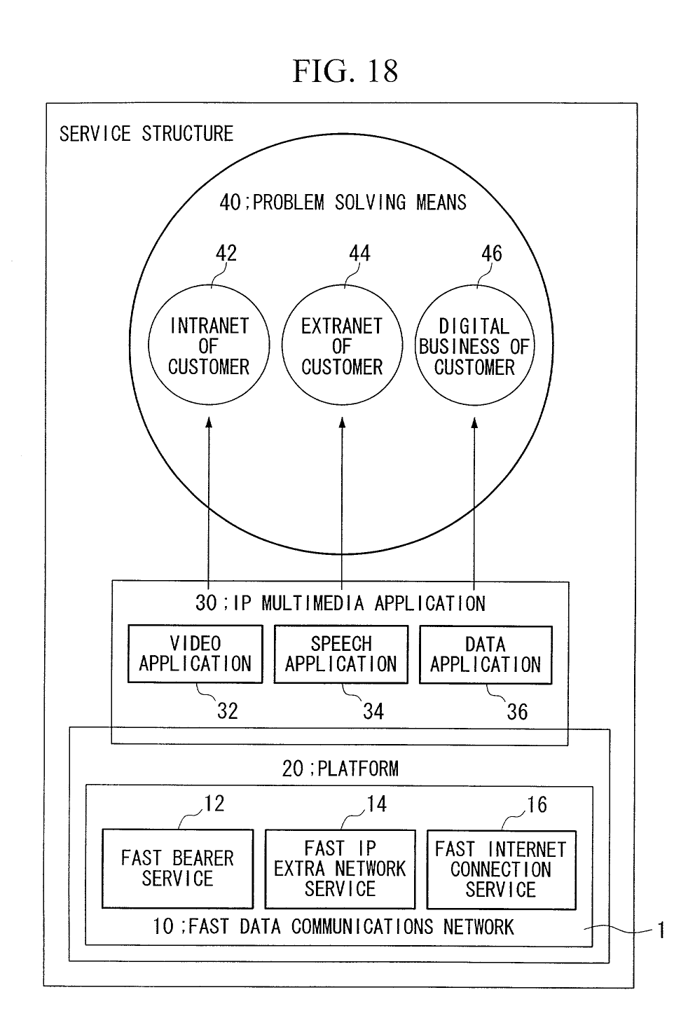

FIG. 19 is a diagram showing an example of communication traffic over a LAN.

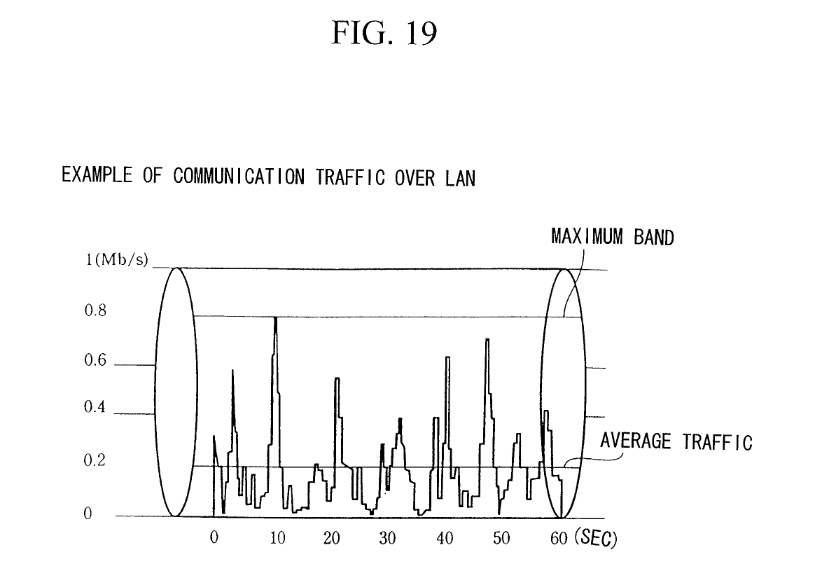

FIG. 20 is an explanatory diagram of an effective band use type service.

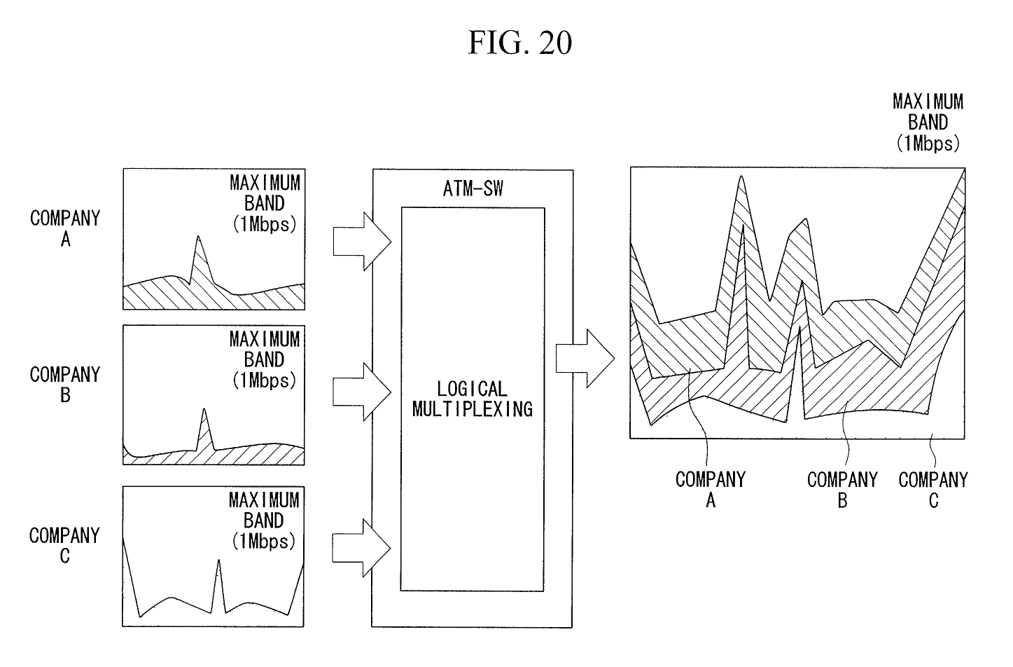

### BEST MODE FOR CARRYING OUT THE INVENTION

Preferred embodiments of the present invention will now be described with reference to the accompanying drawings.

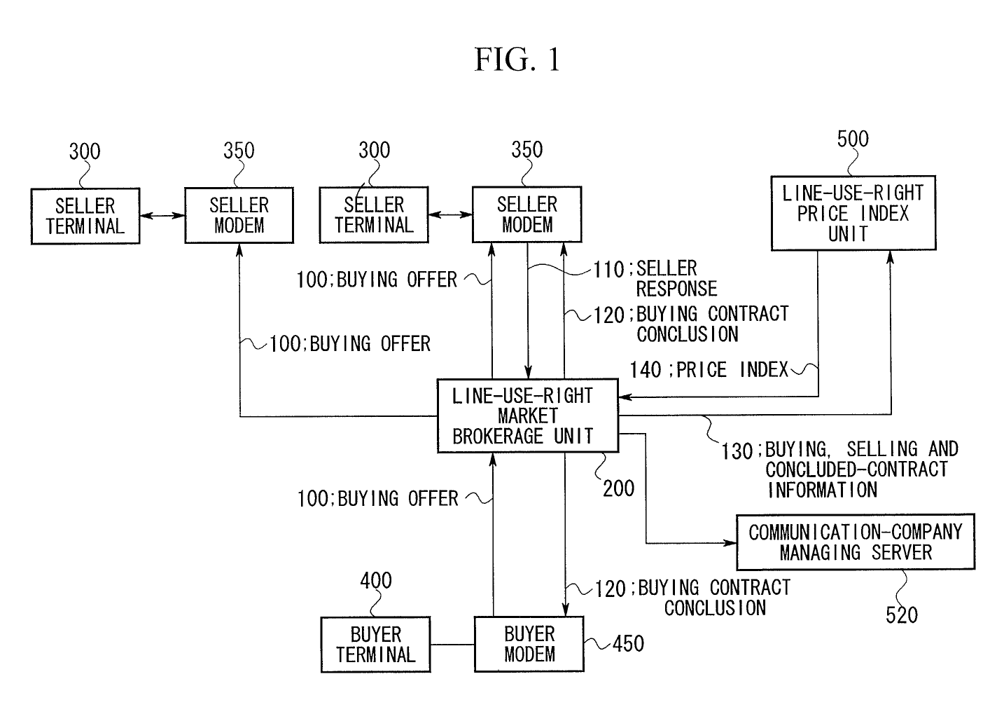

FIG. 1 is a structural block diagram for explaining one embodiment of the present invention. In the figure, an apparatus for trading a line use right which is one type of right to use electric communications equipment has a line-use-right market brokerage unit 200, a seller terminal 300, a buyer terminal 400, a line-use-right price index unit 500 and a communication-company managing server 520. The individual units exchange data with one another by communication lines, which include various lines, such as optical fibers, mobile communications, stationary satellite communications, low-orbital satellite communications, microwave communications and metal lines.

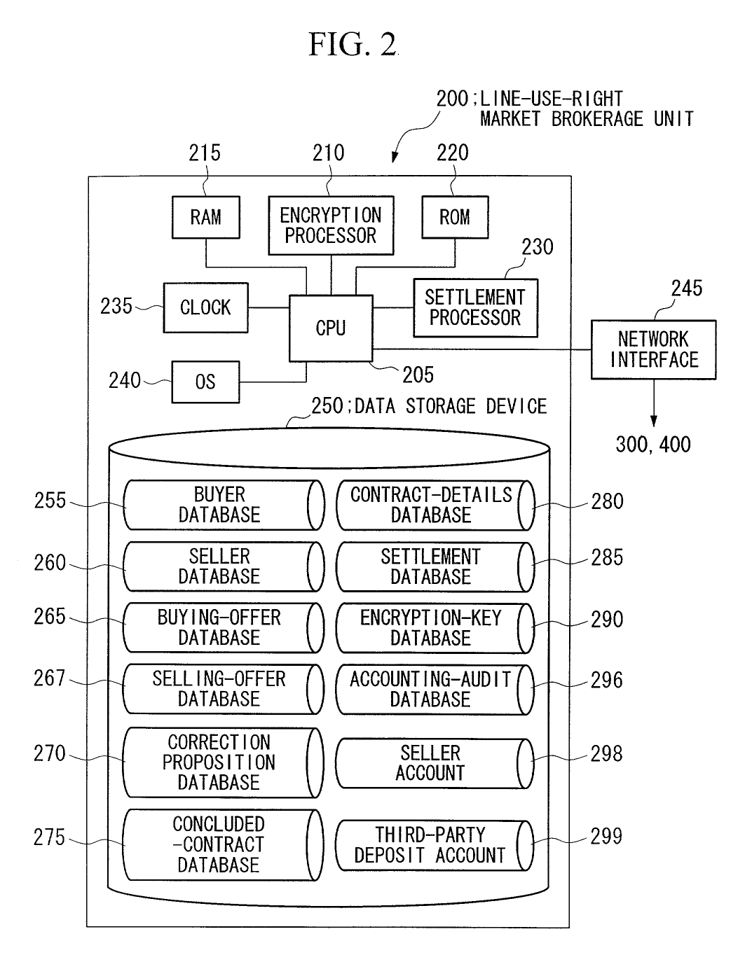

FIG. 2 is a structural block diagram of the line-use-right market brokerage unit. The line-use-right market brokerage unit 200 works as a parent server and intermediates information exchange with the seller terminal 300, the buyer terminal 400 and the line-use-right price index unit 500. An Intel Pentium processor, for example, is used as a CPU (Central Processor Unit) 205. An encryption processor 210 prevents information from leaking to third parties and prevents unauthorized third parties from feeding false trading information to thereby disturb the trade market of line use right, at the time trading information on a line use right is fed through a communication line. A RAM (Random Access Memory) 215 is a work memory area where the CPU 205 and the encryption processor 210 perform arithmetic operations. A ROM (Read Only Memory) 220 stores a program to be executed by the CPU 205 and the encryption processor 210.

A settlement processor 230 supports transfer and exchange of payment, rate charging, debt, etc., and authenticates, for example, settlement accounts and credit cards. A clock 235 is a reference for synchronizing the individual elements that constitute the line-use-right market brokerage unit 200. An OS (Operating System) 240 conforms to the de facto standard, and it may be DOS, WINDOWS, UNIX or the like. A line interface 245 manages the difference in format between internal information of the line-use-right market brokerage unit 200 and information to be transmitted and received over a communication line, and performs conversion to information to packet type information in ATM (Asynchronous Transfer Mode).

A data storage device 250 uses a hard magnetic disk, magneto-optical disk, CD-ROM or the like. As databases to be stored in the data storage device 250, there are a buyer database 255, a seller database 260, a buying-offer database 265, a selling-offer database 267, a correction proposition database 270 for counterproposals to buying offers and selling offers, a concluded-contract database 275, a contract-details database 280, a settlement database 285, an encryption-key database 290, an accounting-audit database 296, a seller account 298, a third-party deposit account 299, and so forth.

The buyer database 255 and the seller database 260 store information on natural persons and juridical persons who participate in trading of line use rights, and have items, such as a name or appellation, an address or registered place of business, a telephone number, an ID number for trading a line use right and e-mail address. The seller database 260 and the buying-offer database 265 store items such as the communication capacity offered in trading a line use right, a date on which trading is to be made, a desired trading price and the communication service quality of the communication capacity to be traded. The concluded-contract database 275 and the contract-details database 280 store items such as the price at which a contract for trading the line use right is concluded, the communication capacity, the trade contract number, the buyer's name and the seller's name. The settlement database 285 stores items such as the trade amount, the settling date, the trade contract number and the currency for payment.

The encryption-key database 290 stores an encryption key at the time the encryption processor 210 encrypts information and sends it, and an encryption key which is used at the time encrypted information is decoded by the encryption processor 210. The target for encryption is the transmission and reception of messages, such as a buying offer 100, a seller response 110, a buying contract conclusion 120, a selling offer, a buyer response and a selling contract conclusion. Information on the conclusion of the trading of a line use right is recorded in the accounting-audit database 296 so that retroactive inspection is possible in later accounting auditing. The seller account 298 records a settlement account number such as a bank account number or a credit card account number of a seller of a line use right. The third-party deposit account 299 is a management account of the cash that is temporarily stored until settlement.

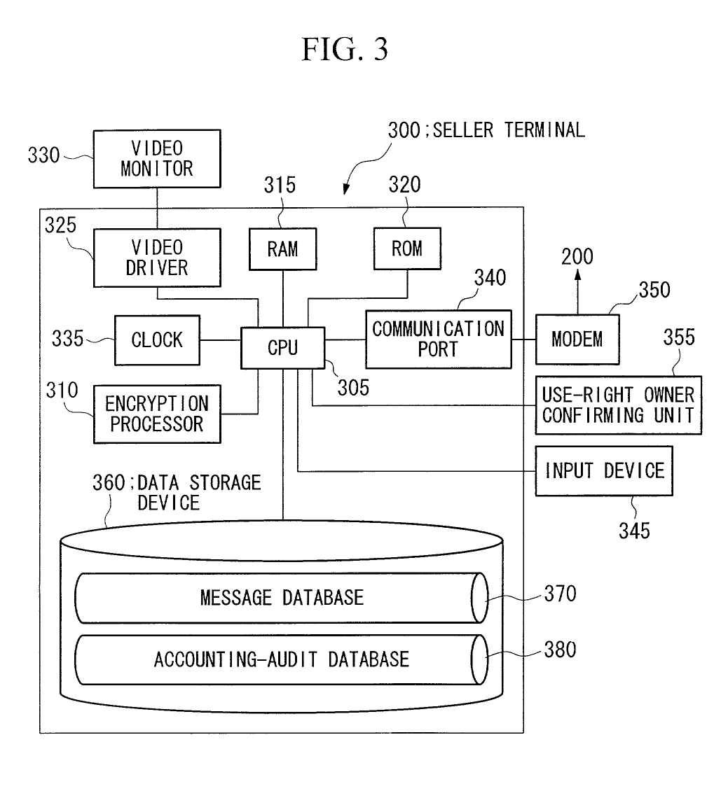

FIG. 3 is a structural block diagram of the seller terminal. The seller terminal 300 is a general-purpose personal computer in which a program for communication to the line-use-right market brokerage unit 200 to trade a line use right is stored. The seller terminal 300 has a CPU 305, an encryption processor 310, a RAM 315, a ROM 320, a video driver 325 which communicates with a video monitor 330 such as a CRT, a communication port 340 and a data storage device 360. A modem 350 is connected to the communication port 340 and communications with the line-use-right market brokerage unit 200 over a communication line. An input device 345 is, for example, a keyboard or a voice input device. A use-right owner confirming unit 355 determines whether an operation by an operator is a legal operation by a registered authentic operator, based on the biological characteristics of the operator, such as a fingerprint or voiceprint.

The data storage device 360 has a message database 370 and an accounting-audit database 380. The message database 370 stores messages for a seller response and a correction proposal. The accounting-audit database 380 has a settlement record of trade prices for rights to use line and a record of communication with the line-use-right market brokerage unit 200.

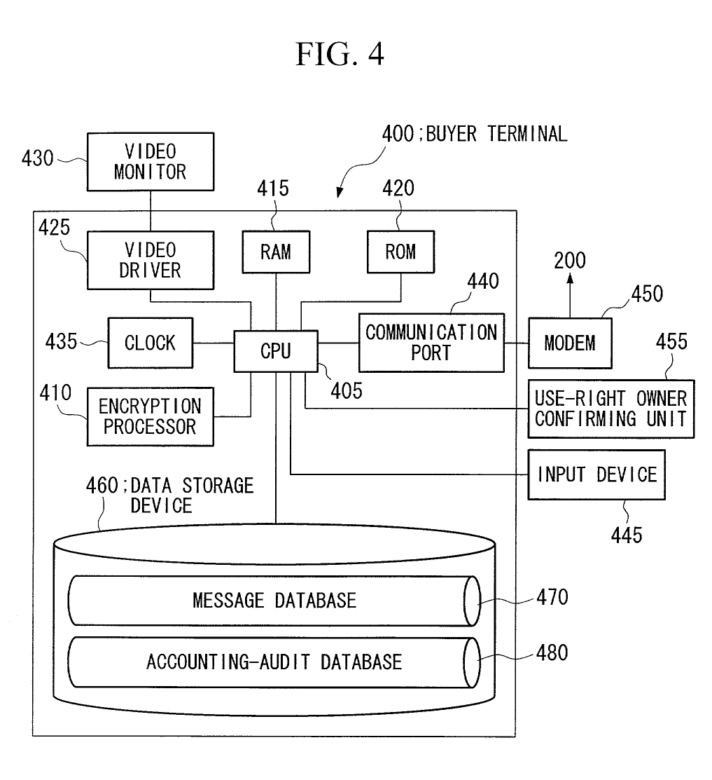

FIG. 4 is a structural block diagram of the buyer terminal. The buyer terminal 400 is a general-purpose personal computer in which a program for communication to the line-use-right market brokerage unit 200 to trade a line use right is stored. The buyer terminal 400 has a CPU 405, an encryption processor 410, a RAM 415, a ROM 420, a video driver 425 which communicates with a video monitor 430 such as a CRT, a communication port 440 and a data storage device 460. Like the seller terminal 300, it further has a modem 450, an input device 445, a use-right owner confirming unit 455, a message database 470 and an accounting-audit database 480.

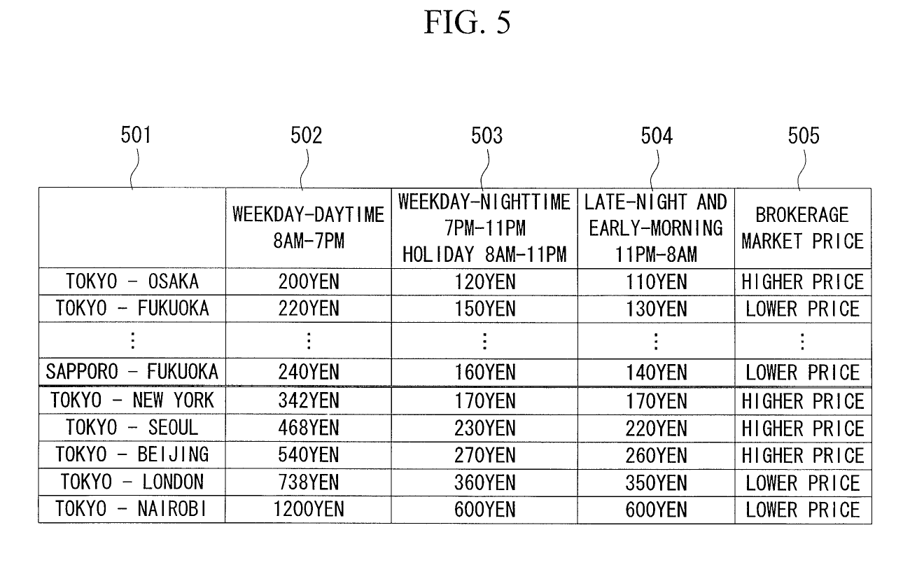

FIG. 5 is an explanatory diagram of a line-use-right price index. The line-use-right price index unit 500 informs sellers or buyers of the trend of quotations on the line use right market to promote trading of line use rights. The line use right price index unit 500 provides, as price indices, a line display column 501, a weekday-daytime charge column 502, a weekday-nighttime and holiday charge column 503, a late-night and early-morning charge column 504 and a brokerage market quotation column 505. For example, the unit price of the right to use a line between “Tokyo and Osaka” by a communication company is 200 yen for daytime on weekdays, 120 yen for nighttime on weekday and on holidays, and 110 yen for late nights and early mornings, and the brokerage market quotation shows a high demand. When the brokerage market quotation shows a high demand, the price for trading a line use right on a temporary basis is shifted higher as compared with the unit price offered by the communication company.

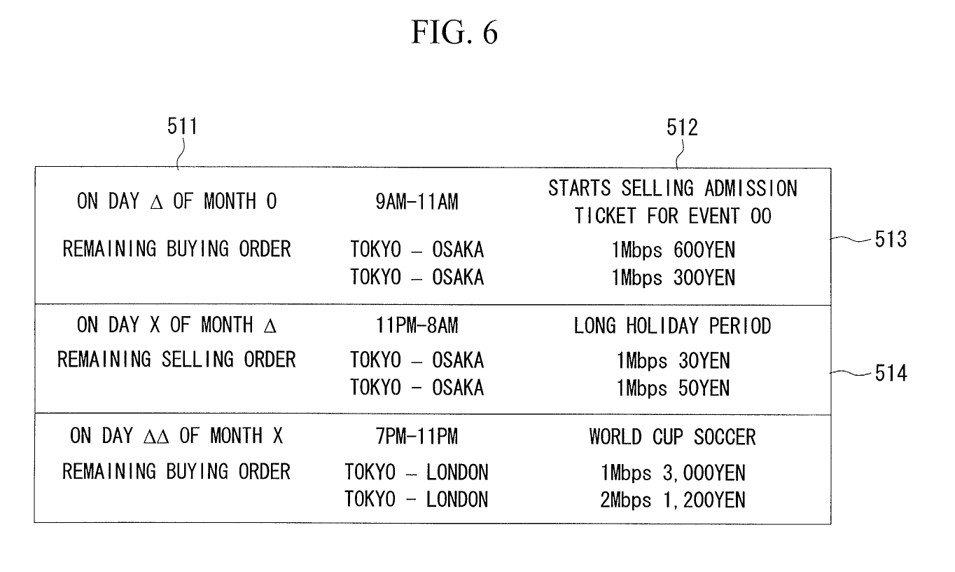

FIG. 6 is an explanatory diagram for buying and selling offers for a line use right. The buying offer and the selling offer are made with a time-of-usage column 511 for the line use right to be traded, the reason for which line use is needed 512, a remaining buying order column 513 and a remaining selling order column 514. For 9 to 11 am on day Δ of month O, for example, as it is predicted that communication line usage will be heavy because the sales of admission ticket for event OO starts, there is a buyer who wants to buy a communication capacity of 1 Mbps between “Tokyo and Osaka” at 600 yen, which is higher than the unit price by the communication company. For 11 pm to 8 am on day X of month Δ during a long holiday period, there is a seller who wants to sell a communication capacity of 1 Mbps between “Tokyo and Osaka” at 30 yen which is lower than the unit price by the communication company. Such trading of a line use right can also be applied to trading over an international data communication network, such as trade between “Tokyo and London”. When trading of a line use right is concluded, the line use right market brokerage unit 200 informs the communication-company managing server 520 of the details of the trading of the line use right, i.e., the seller, the buyer, the time zone of usage of the line use right to be traded, the communication capacity and the concluded prices.

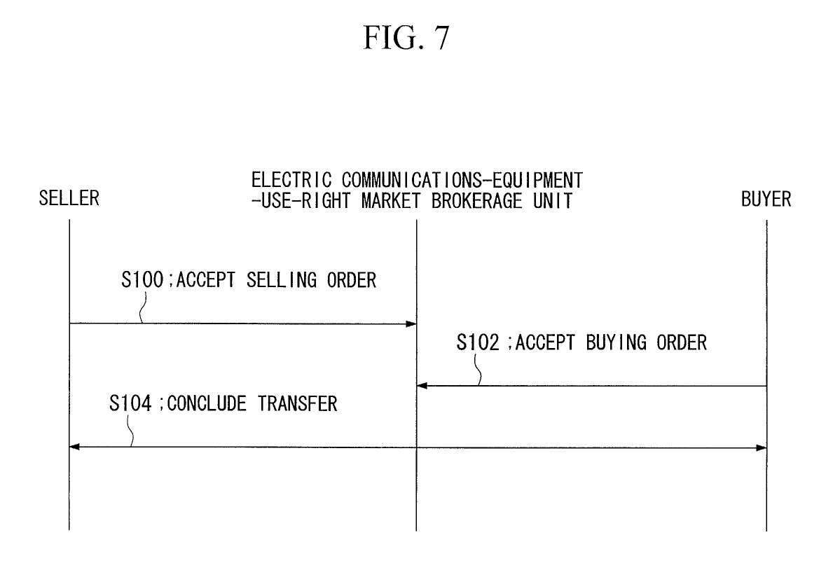

A description will be given of trading of a line use right by the thus constituted apparatus. FIG. 7 is a flowchart for explaining a method of trading a right to use electric communications equipment. Persons who want to trade a line use right, which is an example of rights to use electric communications equipment, register the use of the seller terminal 300 and the buyer terminal 400 in the line-use-right market brokerage unit 200. In the case where both selling and buying can be done, in consideration of the contracted communication capacity with the communication company and the communication traffic demands of the local company, both the seller terminal 300 and buyer terminal 400 are registered.

A person who wants to buy a line use right makes a buying offer to the line-use-right market brokerage unit 200 through the buyer terminal 400 (S102). A person who wants to sell a line use right makes a selling offer to the line-use-right market brokerage unit 200 through the seller terminal 300 (S100). At this time, the indices of the current transaction prices are known by referring to the price index of line use right, and prices close to the current transaction prices are presented in the buying offer and selling offer. The line-use-right market brokerage unit 200 gathers buying offers and selling offers and intermediates in such a way that trading is to be concluded (S104). It is possible to semi-automatically close individual transactions under given conditions by presenting, beforehand, limited prices and the range of transaction allowance conditions on the market, instead of manually closing the individual transactions through the buyer terminal 400 and the seller terminal 300. The limited prices and the range of transaction allowance conditions that are presented on the market beforehand are stored in the buying-offer database 265 and the selling-offer database 267. In this case, when the communication company participates in a buying offer or selling offer and presents a price considerably different from the standard charge locally determined, one should intervene in the market to stabilize the market.

When a contract on the trade of the line use right is concluded, the buyer pays money to the seller through a bank account or a credit card account. Then, the buyer can communicate using the transferred communication line capacity in the time zone specified by the trade contract. The communication company can learn the content of the trade contract using the communication-company managing server 520. As the communication company collects the communication service using charges to be received from the communication users, the communication service using charge and the trade price for the line use right may be balanced out or a substitute collecting function may be performed instead of using a bank account or a credit card account using the settling function involving the communication service using charges.

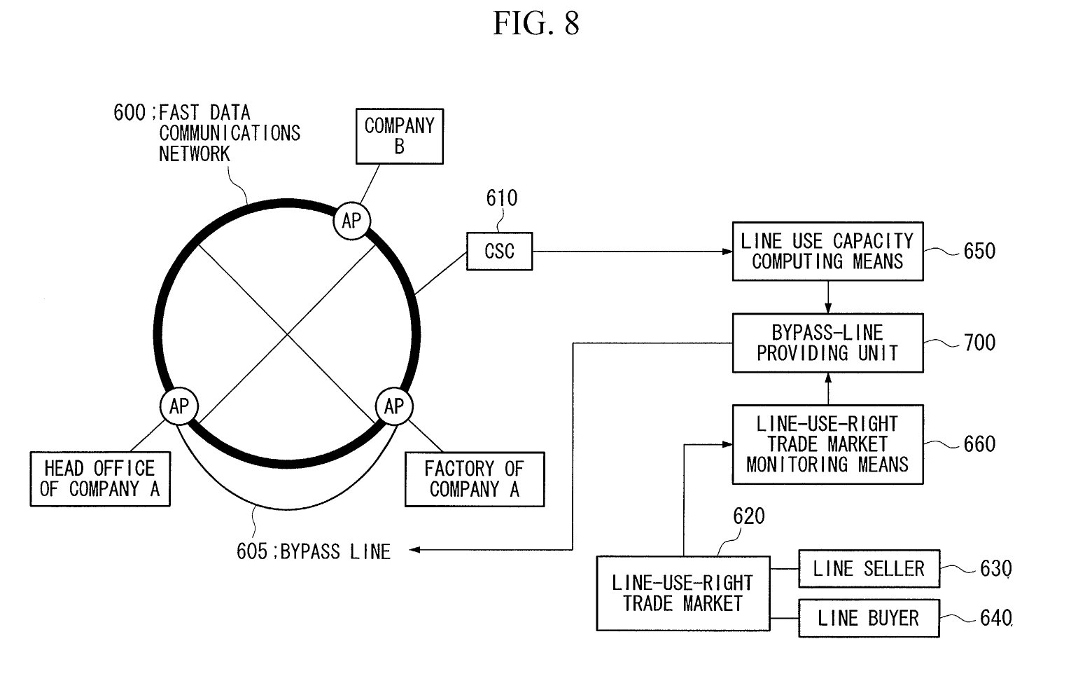

FIG. 8 is a structural block diagram for explaining the first embodiment of an apparatus for assigning the capacity of a communication line. The head office of a company A, a factory of the company A, a company B and a CSC (Customer Service Center) are connected to a fast data communications network 600, which is equipment for electric communications, through access points AP. The CSC 610 manages the quality of the communication traffic and the communication demands on the fast data communications network 600, and takes a bypass action in response to an interruption of communication within a part of the fast data communications network. A bypass line 605, which is equipment for bypassing electric communication lines, is a bypass line provided between the head office of the company A and the factory of the company A.

A line-use-right trade market 620 is a market managed by using the line-use-right market brokerage unit 200, the seller terminal 300, the buyer terminal 400, the line-use-right price index unit 500, etc. shown in FIG. 1. A line seller 630 makes a selling offer for a line use right by using the seller terminal 300. A line buyer 640 makes a buying offer for a line use right by using the buyer terminal 400. Line use capacity computing means 650, which is equivalent to a means for computing an electric-communications-equipment occupation capacity, gathers and analyzes traffic data of registered users of the fast data communications network 600 and computes a network-line use capacity in a unit transaction period for a line use right. The unit transaction period for a line use right may be, for example, 30 minutes or one hour, or may be synchronous with the settlement interval for telephone charges, such as one week or one month. The line-use-right trade market monitoring means 660, which is equivalent to a means for monitoring a right to use electric communications equipment, monitors the communication capacity that is traded on the line-use-right trade market 620 and should preferably be provided in, for example, the communication-company managing server 520.

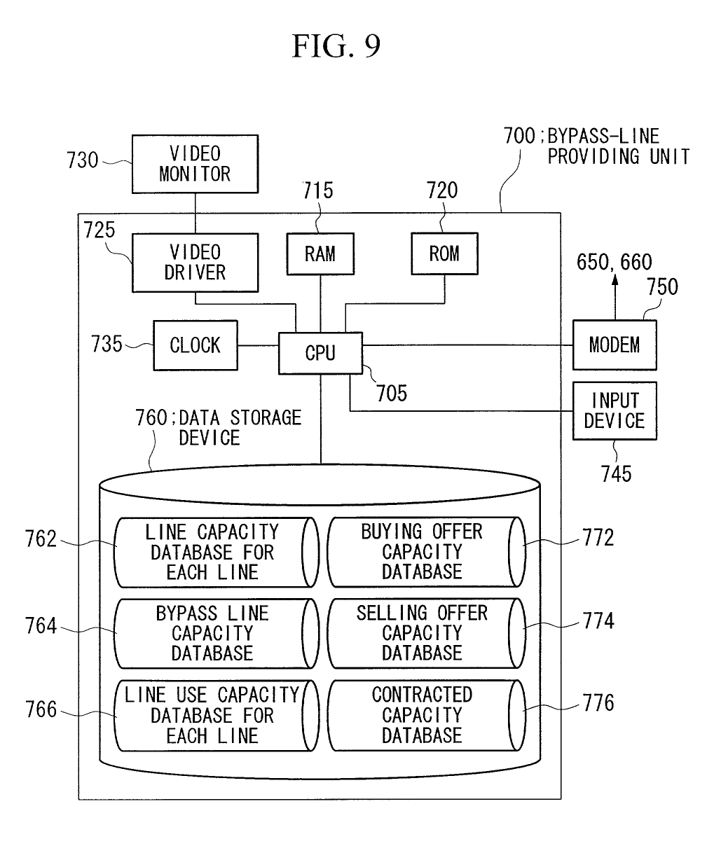

When the line use capacity computing means 650 detects a line on the fast data communications network 600, in which transaction price for the line use right becomes high due to a shortage in the communication capacity provided by a communication company, the bypass-line providing unit 700, as a bypass-electric-communications-equipment providing unit, provides another line having a surplus capacity as the bypass line 605 to bypass the line having insufficient capacity. FIG. 9 is a structural block diagram of a bypass-line providing unit. The bypass-line providing unit 700 is a general-purpose personal computer in which a communication program for the line use capacity computing means 650 and the line-use-right trade market monitoring means 660 is stored in order to determine if the bypass line should be provided. The bypass-line providing unit 700 has a CPU 705, a RAM 715, a ROM 720, a video driver 725 which communicates with a video monitor 730 such as a CRT, and a data storage device 760. Like the seller terminal 300, it further has a modem 750 and an input device 745.

The data storage device 760 has a line capacity database 762 in which communication capacity is stored for each line, a bypass line capacity database 764, a line use capacity database 766 in which line use capacity is stored for each line, a buying offer capacity database 772, a selling offer capacity database 774, and a contracted capacity database 776. The line capacity database 762 stores contracted communication capacities of the registered users of the fast data communications network 600. The bypass line capacity database 764 stores the communication capacities that can be secured among registered users of the fast data communications network 600 using the bypass line 605. The line use capacity database 766 stores the actual or predicted communication traffic that is computed by the line use capacity computing means 650. The buying offer capacity database 772, the selling offer capacity database 774 and the contracted-communication-capacity database 776 store the results of trading rights to use line among registered users of the fast data communications network 600 that are acquired by the line-use-right trade market monitoring means 660.

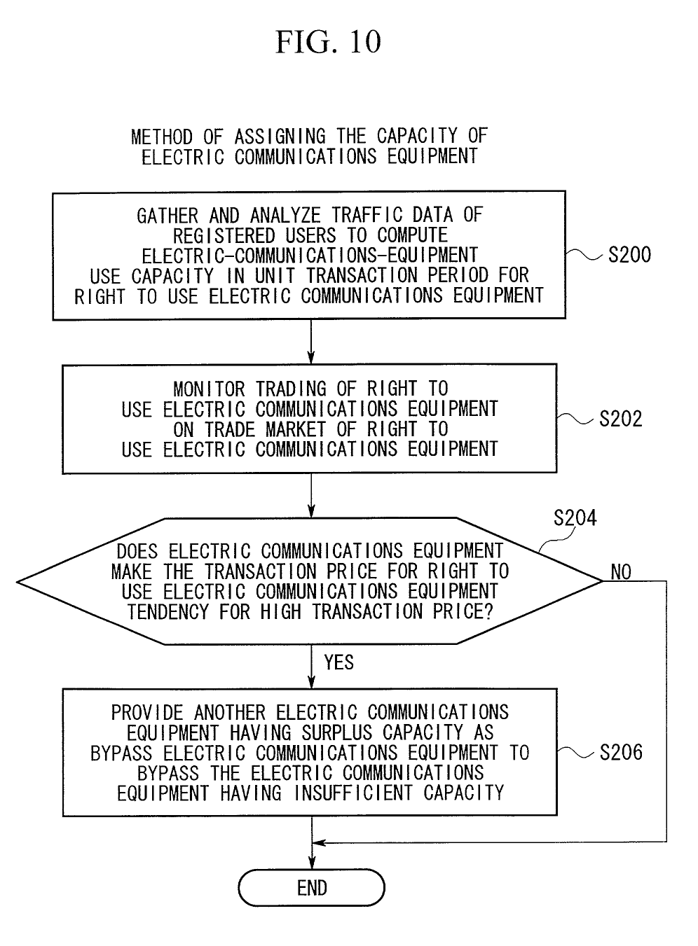

The operation of the thus constituted apparatus will be discussed below. FIG. 10 is a flowchart for explaining a trading method as a method of assigning the capacity of electric communications equipment such as a bypass line. In the figure, first, traffic data of the registered users are gathered and analyzed to computes the usage rate of an electric-communications-equipment over a period equivalent to a time unit for transactions of the right to use the electric communications equipment (S200). Next, the trading of the right to use electric communications equipment that is to be traded on the electric-communications-equipment-use-right trade market is monitored (S202). Then, it is determined whether there is a tendency for high transaction price for the right to use electric communications equipment due to a shortage in the electric communication equipment capacity provided by the communication company in S202 (S204). If it shows a high demand, other electric communications equipment having a surplus capacity is provided as bypass electric communications equipment to bypass the electric communications equipment having insufficient capacity (S206). Specifically, when the communication traffic among registered users of the fast data communications network 600 increases and the contracted communication capacity becomes insufficient, the bypass-line providing unit 700 uses the bypass line 605 to allow the communication traffic among the registered users of the fast data communications network 600, thereby securing the real-time data communication.

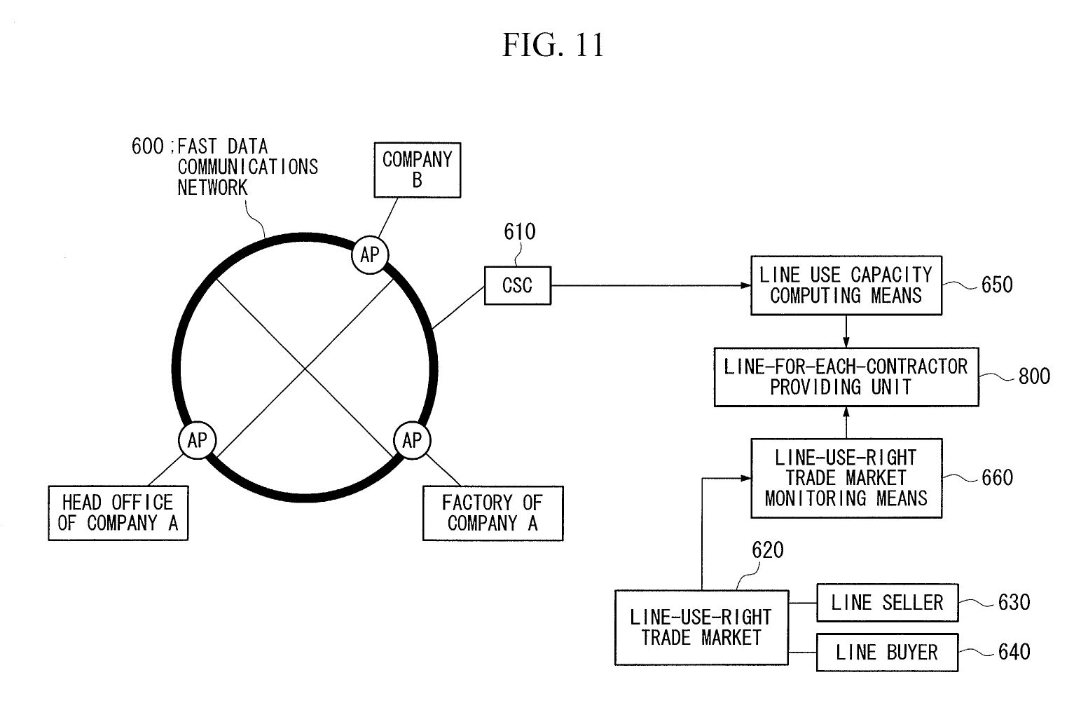

FIG. 11 is a structural block diagram for explaining the second embodiment of an apparatus for assigning the capacity of a communication line. The same symbols are given to the constituents which work in the same way as those in FIG. 8, and their description will be omitted. With respect to a line for which a transaction price for the line use right becomes high due to a shortage in the communication capacity provided by the communication company by the line use capacity computing means 650, a line-for-each-contractor providing unit 800, which is a unit for providing electric communications equipment for each contractor, provides a customer having a contract for the use of a line of a high communication service quality with priority to the communication capacity and provides a customer having a contract for the use of a line of a low communication service quality with delayed access to the communication capacity.

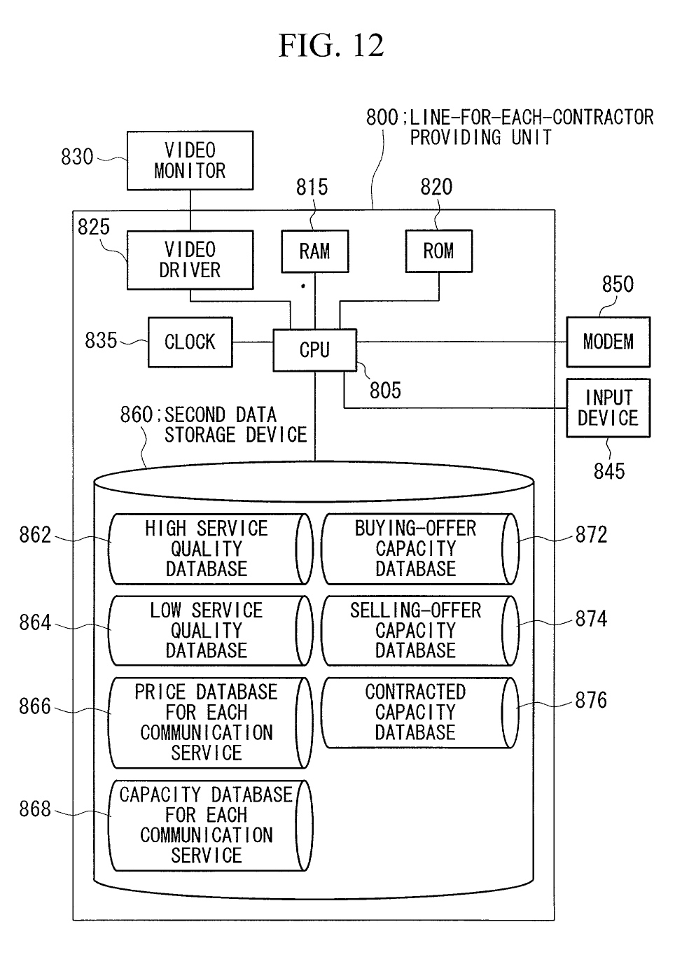

FIG. 12 is a structural block diagram of the line-for-each-contractor providing unit. The line-for-each-contractor providing unit 800 is a general-purpose personal computer in which a communication program for the line use capacity computing means 650 and the line-use-right trade market monitoring means 660 are stored in order to provide distinct communication services for the individual communication service qualities of the contractors. The line-for-each-contractor providing unit 800 has a CPU 805, a RAM 815, a ROM 820, a video driver 825 which communicates with a video monitor 830 such as a CRT, and a data storage device 860. Like the bypass-line providing unit 700, it further has a modem 850 and an input device 845.

The data storage device 860 has a high service quality database 862, a low service quality database 864, a price database 866 in which a price is stored for each communication service, a capacity database 868 in which assigned communication capacity is stored for each communication service, a buying offer capacity database 872, a selling offer capacity database 874, and a contracted capacity database 876. The line-for-each-contractor providing unit 800 makes a decision in such a way that the ratio (a) of the communication capacity secured for a customer who has a contract for the use of a line of a high quality to (b) the communication capacity secured for a customer who has a contract for the use of a line of low communication quality does not excessively deviate from the difference in contracted price between the high communication quality line use and the low communication quality line use, by referring to the price-for-each-communication-service database 866, and writes the assignment results in the communication-capacity-for-each-communication-service assigning database 868.

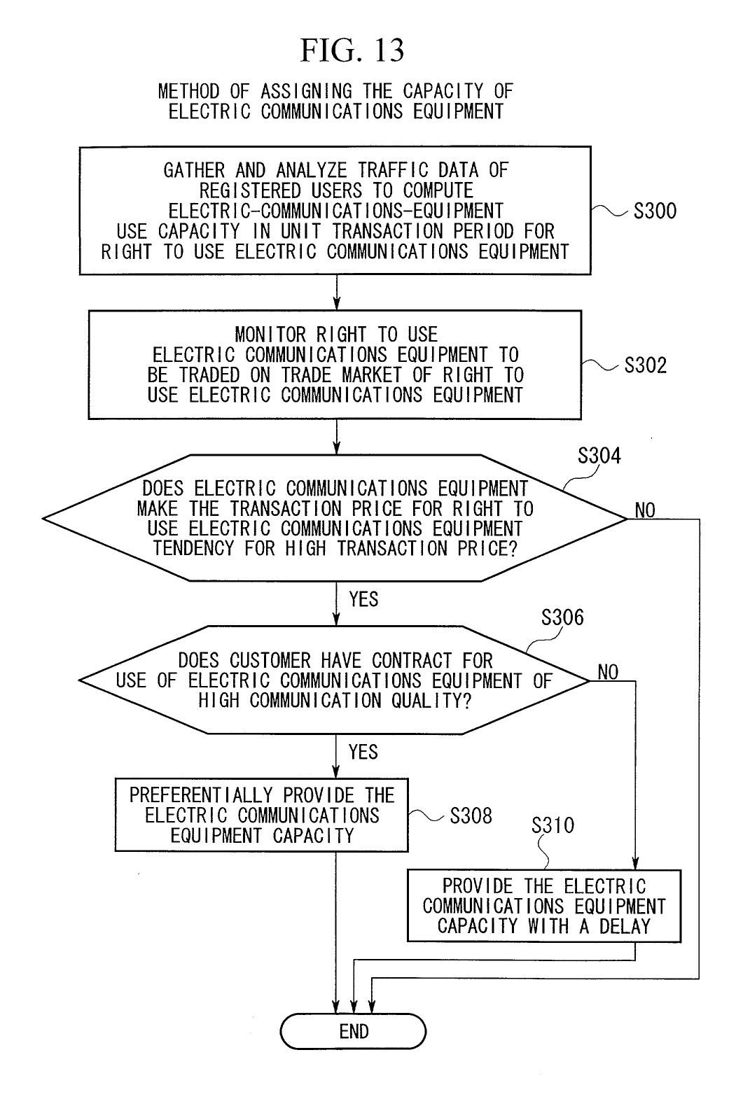

The operation of the thus constituted apparatus will be discussed below. FIG. 13 is a flowchart for explaining a method of assigning the capacity of electric communications equipment such as a communication capacity. In the figure, first, traffic data of registered users is gathered and analyzed to compute the electric-communications-equipment occupation capacity in a unit transaction period for a right to use electric communications equipment (S300). Next, the trading of the right to use electric communications equipment that is to be traded on the right to use electric communications equipment trade market is monitored (S302). Then, it is determined whether there is tendency for high transaction prices for the right to use electric communications equipment due to a shortage in the electric communication equipment capacity provided by the communication company in S302 (S304). If there is a higher price, it is determined whether the customer has a contract for the use of electric communications equipment of high communication quality (S306), and such a customer is provided with electric communications equipment capacity by priority (S308). On the other hand, a customer who has a contract for the use of electric communications equipment of low communication quality is provided with the mentioned electric communications equipment capacity with a delay (S310). In this way, electric communications equipment capacity such as a communication capacity is assigned optimally based on the market mechanism.

Next, an embodiment of an electric-communications-equipment-use-right trading apparatus according to the invention will be described. Type 2 electric communication companies are companies who do not build lines themselves but borrow lines from type 1 electric communication companies and provide electric communications, and correspond to VAN firms, line resale firms and ISP's (Internet Service Providers). Electric communications equipment includes line equipment provided by the type 1 electric communication companies, line equipment provided by type 2 electric communication companies, application equipment provided by the type 2 electric communication companies and ASP servers which are provided for an ASP (Application Service Provider). For such electric communications equipment, when the line capacity contracted by a user is 1.0 Gbps, the processing capacity of the application equipment is 0.5 Gbps and the processing capacity of the ASP server is 1.0 Gbps, for example, the processing capacity of the application equipment becomes a bottleneck. Accordingly, 0.5 Gbps of the user-contracted line capacity are actually used, so that it is difficult to fully utilize the potential capacity.

The user has two options. The first is to reduce the user-contracted line capacity to 0.5 Gbps, and the second is to increase the processing capacity of the application equipment to 1.0 Gbps. It is therefore preferable that a type 2 electric communication company provide a processing scheme for allowing the user to select the second option or the enhancement of the processing capacity of the application equipment. In this case, the user may buy the entire equipment that produces the bottleneck. If a right for temporary use of the equipment can be traded for the purpose of reducing the fixed costs, however, the options available to the user become wider, thus contributing to the customer service. This embodiment provides an electric-communications-equipment-use-right trading apparatus which temporarily trades the processing capacity of equipment, whose limits in processing capacity may produce a bottleneck and which is selected from among electric communications equipment such as line equipment, application equipment and an ASP server.

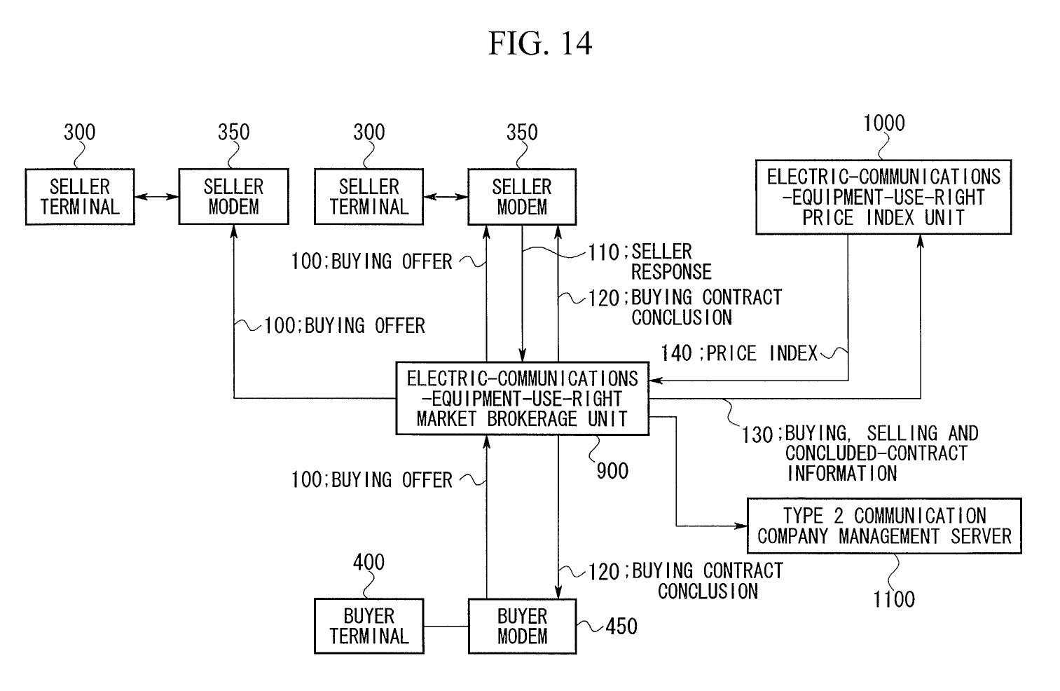

FIG. 14 is a structural block diagram of an apparatus for trading a right to use electric communications equipment. The same symbols are given to the constituents in FIG. 14 which work in the same way as those in FIG. 1, and their description will be omitted. In the figure, the line use right trading apparatus comprises an electric-communications-equipment-use-right market brokerage unit 900, a seller terminal 300, a buyer terminal 400, an electric-communications-equipment-use-right price index unit 1000 and a type 2 electric communication company management server 1100. The structure of the electric-communications-equipment-use-right market brokerage unit 900 conforms to that of the line-use-right market brokerage unit 200, and the structure of the electric-communications-equipment-use-right price index unit 1000 conforms to that of the line-use-right price index unit 500. The structure of the type 2 electric communication company management server 1100 conforms to that of the communication-company managing server 520, and has a CPU, ROM, RAM, modem and databases. As the databases, a customer management database, a charge database and an electric communications equipment database and so forth are provided.

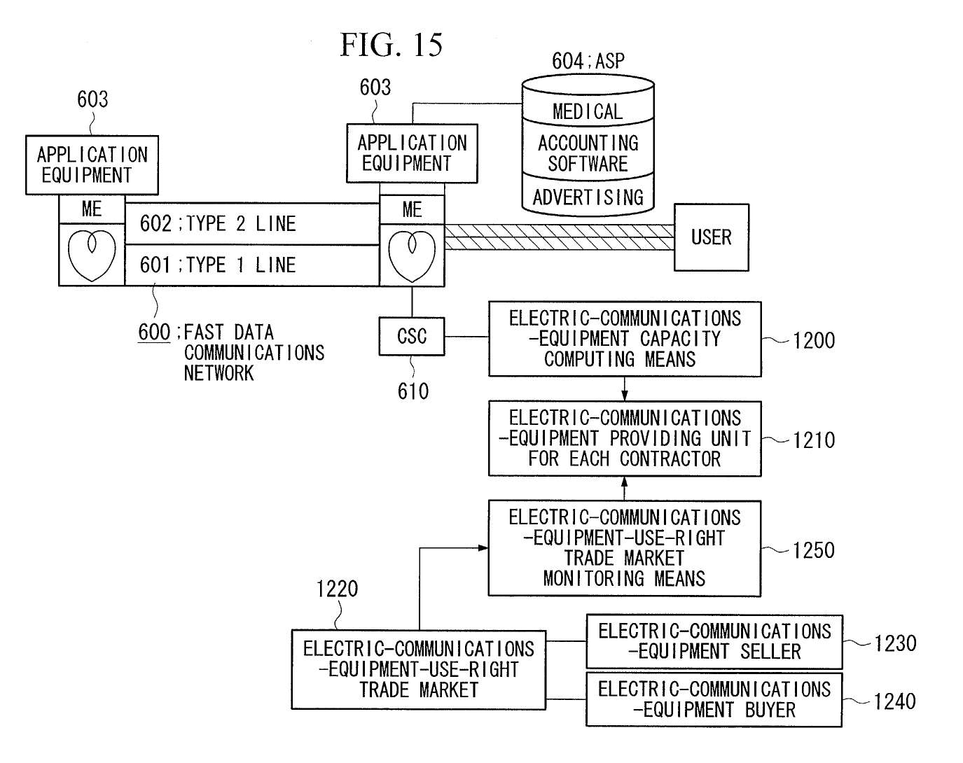

FIG. 15 is a structural block diagram for explaining an apparatus for assigning the capacity of electric communications equipment. The fast data communications network 600 is constructed by a type 1 line 601 provided by a type 1 communication company such as NTT of East Japan (Higashi Nippon Telegraph and Telephone Co., Ltd.), a type 2 line 602 provided by a type 2 electric communication company such as the present applicant, application equipment 603 and an ASP server 604. The application equipment 603 includes a cache memory and a buffer memory for temporarily storing packets at times of congestion. The ASP server 604 includes, for example, medical and accounting software, an advertising server, etc.

An electric-communications-equipment-use-right trade market 1220 is a market managed by using the electric-communications-equipment-use-right market brokerage unit 900, the seller terminal 300, the buyer terminal 400, the electric-communications-equipment-use-right price index unit 1000, etc. shown in FIG. 14. An electric-communications-equipment seller 1230 makes a selling offer for a right to use electric communications equipment by using the seller terminal 300. An electric-communications-equipment buyer 1240 makes a buying offer for a right to use electric communications equipment by using the buyer terminal 400. Electric-communications-equipment capacity computing means 1200 gathers traffic data of registered users of the fast data communications network 600 through the CSC 610 for analyzing the gathered traffic data, and computes the usage rate of an electric-communications-equipment over a period equivalent to a time unit for transactions of the right to use the electric communications equipment. The period equivalent to a time unit for transactions of the right to use the electric communications equipment may be, for example, 30 minutes or one hour, or may be synchronous with the settlement interval for telephone charges, such as one week or one month. An electric-communications-equipment-use-right trade market monitoring unit 1250 monitors the right to use electric communications equipment that is traded on the electric-communications-equipment-use-right trade market 1220 and should preferably be provided in, for example, the type 2 communication company management server 1100.

According to the thus constituted apparatus, when the communication traffic among registered users of the fast data communications network 600 increases and the contracted electric communications equipment capacity becomes insufficient, real-time data communication is guaranteed by supplementing the insufficient electric communications equipment capacity of the fast data communications network 600 by using the electric-communications-equipment-use-right trade market 1220. Because the electric communications equipment capacity that is traded by the electric-communications-equipment-use-right trade market 1220 is for a temporary use right, users can treat fluctuations in electric communications equipment capacity as a fluctuating cost.

Although the foregoing description of the embodiment has been given for the case where a seller terminal is provided for a communication line user who has made a contract with a communication company, the invention is not limited to this case but may be designed in such a manner that seller terminals are provided in a plurality of communication companies or exclusive-line resale firms and a communication company or an exclusive-line resale company tenders a bid for a buying offer input through a buyer terminal by a communication line user.

### INDUSTRIAL APPLICABILITY

The invention provides an apparatus for trading a right to use electric communications equipment, which can permit an electric communications equipment user, who is renting electric communications equipment, such as a network line, from a communication company, to share electric communications equipment capacity with other electric communications equipment users and the communication company when there is a temporary excess or a deficiency of electric communications equipment capacity. The invention also provides an apparatus for assigning the capacity of electric communications equipment, which provides electric communications equipment on another path that handles excess demands or flexibly changes the assignment of electric communications equipment capacity among electric communications equipment users in conformity with the communication service quality with an electric communications equipment user, when the use by the electric communications equipment user, who is renting electric communications equipment, such as a network line, from a communication company, temporarily exceeds the electric communications equipment capacity.

1. An apparatus for trading a right to use electric communications equipment comprising:
means which accepts a consignment to sell a right to use electric communications equipment corresponding to a surplus electric communications equipment capacity a first registered user has contracted with a communication company;
means which accepts a consignment to buy a right to use electric communications equipment corresponding to a shortage of electric communications equipment capacity a second registered user has contracted with a communication company; and
market brokerage means which mediates between said consignment to sell said right to use electric communications equipment of said first registered user and said consignment to buy said right to use electric communications equipment of said second registered user to conclude the transfer of said right to use electric communications equipment.

2. The apparatus for trading a right to use electric communications equipment according to claim 1, further comprising electric-communications-equipment-use-right price index means which collects the price of said consignments to sell and the price of said consignments to buy said right to use electric communications equipment from said registered users, and which sets a lower unit price for said right to use electric communications equipment in a period in which the price of said consignments to sell said right to use electric communications equipment exceed the price of said consignments to buy, and which sets a higher unit price for said right to use electric communications equipment in a period in which the price of said consignments to sell said right to use electric communications equipment is below the price of said consignments to buy.

3. The apparatus for trading a right to use electric communications equipment according to claim 1 or 2, wherein said right to use electric communications equipment includes at least one of a line use right, a right to use application equipment and a right to use an ASP server, and said electric communications equipment capacity includes at least one of a line capacity, an application equipment processing capacity and an ASP server processing capacity.

4. An apparatus for assigning a capacity of electric communications equipment, comprising:
means which collects and analyzes traffic data of registered users and computes the usage rate of an electric-communications-equipment over a period equivalent to a time unit for transactions of the right to use the electric communications equipment;
monitoring means which monitors the trading of said right to use electric communications equipment to be traded in a market for trading said right to use electric communications equipment; and
means which provides other electric communications equipment having a surplus capacity as bypass electric communications equipment to bypass electric communications equipment having insufficient capacity, for electric communications equipment for which said monitoring means determines that the transaction price for said right to use electric communications equipment becomes high due to a shortage in electric communications equipment capacity provided by a communication company.

5. An apparatus for assigning a capacity of electric communications equipment, comprising:
means which collects and analyzes traffic data of registered users and computes the usage rate of an electric-communications-equipment over a period equivalent to a time unit for transactions of the right to use the electric communications equipment;
monitoring means which monitors the trading of said right to use electric communications equipment to be traded in a market for trading said right to use electric communications equipment; and
a unit for providing electric communications equipment for each contractor which, for electric communications equipment for which said monitoring means determines that a transaction price for said right to use electric communications equipment becomes high due to a shortage in electric communications equipment capacity provided by a communication company, preferentially provides a customer having a contract for high communication quality use of electric communications equipment with electric communications equipment capacity, and subsequently provides a customer having a contract for low communication quality use of electric communications equipment with said electric communications equipment capacity.

6. The apparatus for assigning a capacity of electric communications equipment according to claim 5, comprising means which makes a decision in such a way that a ratio of (a) an electric communications equipment capacity secured by said unit for providing electric communications equipment for each contractor, for a customer having a contract for high communication quality use of said electric communications equipment to (b) an electric communications equipment capacity secured by said unit for providing electric communications equipment for each contractor, for a customer having a contract for low communication quality use of said electric communications equipment, does not excessively deviate from the difference in contracted unit price between the high communication quality use and the low communication quality use.

7. A method of trading a right to use electric communications equipment, comprising:
a step of accepting a consignment to sell a right to use electric communications equipment corresponding to a surplus electric communications equipment capacity a first registered user has contracted with a communication company;
a step of accepting a consignment to buy a right to use electric communications equipment corresponding to a shortage of electric communications equipment capacity a second registered user has contracted with a communication company; and
a market brokerage step of intermediating between said consignment to sell said right to use electric communications equipment of said first registered user and said consignment to buy said right to use electric communications equipment of said second registered user to conclude the transfer of said right to use electric communications equipment.

8. A method of assigning a capacity of electric communications equipment, comprising:
a step of collecting and analyzing traffic data of registered users and computing the usage rate of an electric-communications-equipment over a period equivalent to a time unit for transactions of said right to use the electric communications equipment;
a monitoring step of monitoring the trading of said right to use the electric communications equipment in a market for trading said right to use electric communications equipment; and
a step of providing other electric communications equipment having a surplus capacity as bypass electric communications equipment to bypass electric communications equipment having insufficient capacity, for which said monitoring step determines that the transaction price for said right to use electric communications equipment becomes high due to a shortage of electric communications equipment capacity provided by a communication company.

9. A method of assigning a capacity of electric communications equipment, comprising:
a step of collecting and analyzing traffic data of registered users and computing the usage rate of an electric-communications-equipment over a period equivalent to a time unit for transactions of said right to use the electric communications equipment;
a monitoring step of monitoring the trading of said right to use electric communications equipment to be traded in a market for trading said right to use electric communications equipment; and
a step of providing electric communications equipment for each contractor which, for electric communications equipment for which said monitoring step detects that a transaction price for said right to use electric communications equipment becomes high due to a shortage of electric communications equipment capacity provided by a communication company, a customer having a contract for high communication quality use of electric communications equipment is preferentially provided with electric communications equipment capacity, and subsequently a customer having a contract for low communication quality use of electric communications equipment is provided with said electric communications equipment capacity.
